(19) United States
(12) Patent Application Publication
(10) Pub. No.: US 2010/0101479 A1
(43) Pub. Date: Apr. 29, 2010

(54) Telescopic flagpole

(76) Inventors: Kenneth Grahl, Fond-Du Lac, WI (US); Nathaniel Grahl, Fond-Du Lac, WI (US)

Correspondence Address: JACOBSON HOLMAN PLLC, 400 SEVENTH STREET N.W., SUITE 600, WASHINGTON, DC, 20004, US

(21) Appl. No.: 12/289,403

(22) Filed: Oct. 27, 2008

(51) Int. Cl. G09F 17/00

(52) U.S. Cl. 116/173

(57) ABSTRACT

A dual purpose flagpole has a plurality of elongated telescopic tubular sections for connecting vertically in a fully extended position to form a flagpole, and for collapsing telescopically in a nested position into the bottom tubular section. Each section has a smaller upper end and a larger lower end for forming a tapered tubular pole. Connectors for attaching a flag to the flagpole allow the flag to rotate freely in the wind so as to prevent the flag from wrapping around the flagpole. A foldable support stand for portable use of the flagpole includes a tubular support member, a rectangular plate, and foldable braces. For permanent use, each of the tubular sections has an aperture and a threaded fastener to provide additional structural integrity for the flagpole in the extended position. Different colors and shapes of figures on the outer surface of the flagpole resemble the theme of the flag.

### BACKGROUND OF THE INVENTION

1. Field of the Invention

The present invention relates generally to telescopic flagpoles and, more particularly, to tubular telescopic flagpoles with support structures to support the flagpole and attach a flag, banner, or pennant thereto and custom paint designs applied to the exterior surface thereof to depict a school, holiday, corporation, corporate logo, event, product, organization, institution, premium, or promotional activity.

2. Description of the Prior Art

Originally, flagpoles were one piece. However, as the need or desire to fly flags, banners or the like permeated to individual citizens, the flag industry sought to make poles less cumbersome, portable and easy to use and store.

Telescopic poles with a friction fit between pole sections have been known for a number of years but only for use in a horizontal position, such as for fishing poles. Recently, telescopic poles have been utilized as flagpoles. However, an ongoing problem exists of keeping the telescopic flagpole extended in the vertical position. In the vertical position, telescopic or expandable poles have been limited because gravity causes the expanded pole sections to collapse due to the weight of the top member or upper members. Mostly, the weight of the top member is caused by the flag supported thereon. This weight has resulted in the use of set screws or other clamp devices to secure the flagpole sections in their extended position.

Preferably, a telescopic flagpole includes an upper section or sections that are collapsible into a lowermost section, thus providing a portable pole of a convenient length for handling and storage. Such poles are expandable because they utilize telescoping pole sections with the lowermost pole section typically having the largest inside diameter and each upper pole section having a correspondingly decreasing diameter so that the upper pole sections can collapse into or expand from inside a preceding larger pole section. As mentioned above, a problem exists with such telescopic poles is that, when in a vertical position, the tubular sections collapse into each other because of gravity and the weight of the flag attached to the smallest topmost section.

The prior art offers many solutions to this problem. Mostly, the prior art focuses on attachments to the pole such as threaded collars, reduced diameter male insert ends, and spring loaded pins to hold each section or member in position. Examples of such attachments to the pole sections can be found in the following U.S. patents.

U.S. Pat. No. 1,297,578 to Lindstaedt discloses a collapsible flagpole made of heavy metal such as malleable iron or the like and the two sections are not collapsed telescopically since the apex of the top section is located adjacent the bottom of the lower section when in collapsed position. In this flagpole, the top tubular section is first separated from the lower section, then inverted end for end and inserted into the bottom section with the apex of the pole extended to the bottom of the lower tubular section.

U.S. Pat. No. 2,787,484 to Macy discloses a sectional fishing rod in which the guides and ferrules prevent the telescopic movement of the upper sections from completely entering into the bottom section.

U.S. Pat. No. 5,572,835 to Atkins discloses a top most rotatable device rotatable but not slidable along the flagpole while the bottom rotatable device is both rotatable and slidable.

U.S. Pat. No. 5,495,821 to Brewer discloses a single connector that rotates on a pair of guides.

U.S. Pat. No. 2,799,240 to Andrews discloses a pair of split ring or collar members but only one split ring is between the flagpole and a ring located on both sides of each annular member. In Andrews the open ring rotates in a recessed annular groove.

U.S. Pat. No. 5,520,141 to Lutz discloses panels permanently bolted to the side of a boat.

U.S. Pat. No. 3,225,734 to Bule discloses extensible flagpole having a lower tubular section which has a tapered lower end for insertion into the ground and a pair of gaskets to retain a center section in a vertical extended position. A smaller diameter telescoping top section having a flag attached thereto is telescoped in relation to the center section. When not in use, the flag is wrapped around the top member and both telescopic sections are collapsed downwardly into the lower tubular section.

U.S. Pat. No. 3,263,382 to Tourtellotte discloses another vertically extendable flagpole. The base member has a point for driving the pole into the ground. Each tube section of the flagpole telescopes into the next larger section. The sections are made of steel tubing. To keep the pole sections in an extended vertical position, clamping members or collars are positioned at the top of each larger section and surround the base of the next smaller section. Screws which extend through the collar and into the base of the next smaller section hold the collars in place and the sections in their extended vertical position.

U.S. Pat. No. 4,918,896 to Wiese discloses a telescopic flagpole in which the telescoping pole segments are retractable and expandable. Each progressively extended segment fits into the preceding segment. Once extended, the bottom of each upper segment connects with the top of the next lower segment by a spring loaded pin. To mount the flagpole, the bottommost section fits into a tubular socket previously encased in concrete. Each pole segment is locked into place at its maximum extension when the shoulder engages a stop ring. At this point, a spring loaded pin in the bottom of the upper segment is urged outwardly and engages with an aligned locking hole in the top of the lower segment.

U.S. Pat. No. 5,540,017 to Eilam et al. discloses a locking device similar to Wiese and is also utilized in a telescopic flagpole. The telescoping tubular segments are connected by a spring loaded pin. When the segments are extended into position, the spring biases the pin into a hole adjacent the upper end of the larger, lower segment. However, the upper end of the lower segment also includes a locking device for engaging the lower end of the upper segment to limit relative rotational movement between the segments.

U.S. Pat. No. 6,009,837 to McClasky discloses another telescoping pole, for a birdhouse or a flag. After the non-rotating telescoping pole is fully extended, each upper section has at least one and preferably two vertically aligned holes. A pin, from the inner section, is biased outwardly into the hole of the upper section. A spring clip holds the pin in place.

Problems which may occur with the foregoing prior art flagpoles reside in the attachments and other hardware such as threaded collars and spring loaded pins which are required to hold the sections in the extended position when the assembled flagpole is put in an upright position.

Another problem area that may exist in telescoping flagpoles is the structure for effectively supporting the extended flagpole from the ground or other supporting surface. Some of the above-described prior patents use a base cemented into the ground. Either a shorter receiving pole is cemented thereto or the pole itself is permanently cemented in place. This is a problem, however, because once the flagpole is placed, the pole or its base cannot be removed.

A further problem with the prior art flagpoles resides in the attachment of the flag. Most of the prior art patents use a latching device for the flag or use some sort of slot mechanism. For example, the Eliam et al. patent has a circular clamp which attaches to the pole and to the flag. In U.S. Pat. No. 5,485,700 to Van Vranken a securement slot is used to secure the flag to the pole. U.S. Pat. No. 5,522,342 to Chen-Chao has a rotating member which prevents the flag from wrapping around the pole.

In addition, the prior art patents fail to disclose that the exterior surface of a flagpole can be selectively painted with figures and backgrounds of different shapes and colors to identify with sports teams, schools, organizations, groups, holiday celebrations, corporate logos, business entities, the environment, events, states, countries, political parties, and the like in which flags are used.

Finally, the flagpoles that are described in the prior art are typically not dual purpose in terms of the services in which they can be employed. That is, those prior art flagpoles that can be telescopically extended and that are portable usually do not have the structural integrity that is required of a flagpole to be subjected to extended use or permanent service. And, conversely, those prior art flagpoles that have adequate structural integrity are usually not easily collapsible and portable, and thus not suitable for temporary use.

### SUMMARY OF THE INVENTION

In order to overcome the problems and disadvantages of the prior art telescoping flagpoles, the present invention provides a dual purpose multi-section, telescopic flagpole that offers the mechanically simple combination of a “pull and twist” friction-lock feature and a threaded fastener to connect each section to its adjacent section or sections. The flagpole sections are preferably made from a reinforced polymeric material, such as fiberglass or graphite reinforced polymer, which is formed with a slight taper so as to achieve the unique friction-lock feature of the present invention. The tapering is such that the exterior surface of the lower end of each section is slightly larger than the interior surface of the upper end of the smaller next upper section so that these ends frictionally lock when the upper section is pulled upwardly to engage the exterior surface of the lower end thereof with the interior surface of the upper end of the lower section. This frictional engagement coupled with the lightweight, yet durable, material of the pole sections ensures that the sections remain extended when the fully extended pole with a flag thereon is positioned in a vertical upright position.

The taper in the tubular sections for forming the telescopic flagpole of the present invention facilitates the easy and fast setup and takedown of the flagpole. To extend the flagpole of the present invention, the pole sections are simply pulled out with respect to each other and extended to their full length, so that friction holds the lower end of a smaller upper section in the upper end of a larger lower section when the sections are fully extended and the flagpole is in an upright position. The tapering of the sections is small, on the order of less than 3°, and preferably about 1° to about 2°. If desired, the interior surfaces of the tubular sections can be made of a material which enhances the frictional engagement between sections when extended.

To provide additional structural integrity for the telescopic flagpole, especially when the flagpole is to remain in the erected position for an extended period of time, at least one of the tubular sections includes in the upper section end thereof an aperture that is configured to engagingly receive the threaded fastener. Each threaded fastener is configured to self thread into each respective aperture so as to provide additional structural integrity for the telescopic flagpole in the extended position. Once the threaded fastener has been threaded into the aperture, a bottom end of the threaded fastener extends through the upper section end so as to frictionally engage an outer surface of the lower end of the next higher section. For extended use and even permanent use, this additional connection provided by the aperture and the threaded fastener securely locks the plurality of elongated sections in the fully extended position.

It is also preferable that the taper of all the flagpole sections be substantially the same so that they neatly nest, each smaller upper section within the next larger lower section when the sections are collapsed within each other for storage. The lowermost or bottom flagpole section is therefore the largest section in length and tapering diameter, and all of the other flagpole sections are preferably slightly shorter than the lowermost section. Hence, when the sections are telescopically collapsed into one another, the bottom section completely houses all of the other flagpole sections for convenient transport and storage.

The bottom end of the lowermost or bottom section of the flagpole is provided with an end plug of rubber or plastic that seals the bottom end of the lowermost section of the flagpole in either the extended flag waving condition or the collapsed storage condition. The lowermost portion of the bottom end plug has the same or slightly larger external diameter as the bottom end portion of the lowermost section of the flagpole. This feature allows the flagpole to be held securely in a vertical position and allows the flagpole to easily slide into a tubular pole support used when supporting or mounting the flagpole. The bottom end plug has an upper portion telescoped into and secured to the bottom end of the lowermost section and secures all the flagpole sections in place by not allowing the smaller upper sections to fall from the bottom of the largest lowermost section of the flagpole. The sealed bottom of the lowermost section prevents moisture and dirt particles from entering the inside of the flagpole that could reduce the friction locking effect of the flagpole sections when extended. The lowermost portion of the end plug includes a bottom surface designed to protect the bottom of the pole from the shock of dropping the pole into a holder, the act of collapsing the pole, and keeping the flagpole secure in holders because of the non-slip external surface retarding any slipping of the bottom end of the flagpole when it is in the extended vertical condition.

A top end plug of rubber of plastic is also provided in accordance with the present invention for capping the top of the lowermost or bottom section when the upper flagpole sections are collapsed completely into the lowermost section. The top end plug includes a downward tubular extension having an outer diameter slightly smaller than the inner diameter of the upper end of the lowermost section to form a snug telescopic friction fit therein for securing the plurality of smaller upper sections within the larger lowermost section, when collapsed for storage. The downward tubular extension has an inner diameter to snugly telescopically receive a depending exterior of a decorative top member to cap the flagpole when the pluralities of elongated telescopic tubular sections are fully collapsed into the bottom largest section.

Connector assemblies are provided in accordance with the present invention which allow the flag to rotate freely on the flagpole as the wind redirects the flag without the flag wrapping around the flagpole. Each connector assembly includes a split, resilient circular ring or collar with an external peripheral recess which rotatably supports a rigid annular ring. The resilient split collars are sized to mount slidably and resiliently lock on the top tubular section of the flagpole to accommodate different size flags. The rotatable annular rigid ring includes a small rigid connector or loop mounted on the periphery thereof for receiving spring clips to attach the flag to the upper section of the flagpole.

A portable and foldable pole holder is also provided in accordance with the present invention. Such a pole-holder allows the extended flagpole to be easily supported in its vertical upright position on the ground, piers, docks, boats and other solid horizontal surfaces, or on the ground or pavement beneath a tire of any type of vehicle, for example, an automobile or truck tire.

To ensure that the flagpole holder can be used with telescopic flagpoles of various lengths, an insertable sleeve is provided for the holder. The insertable sleeve is a rigid annular ring with an outer diameter that is smaller than the inner diameter of the holder, and that has a layer of material thereon that can frictionally engage the inner surface of the flagpole holder. With the insertable sleeve inserted in the holder, a shorter length flagpole, i.e., one having a bottommost tubular section with a lesser diameter, can be supported in the holder.

Another portable pole holder is also provided in accordance with the present invention. Typically employed for temporary use of the flagpole, the support is portable and is configured to receivingly engage the bottom tubular section of the flagpole and be removably insertable into the ground. The support includes a shaft with an upper section having a plurality of bottom tubular section support disks disposed along an axis of the shaft. The disks are configured to frictionally engage and support an inner surface of the flagpole's bottom tubular section. A ground surface engaging disk disposed on the shaft beneath the disks has an outer edge with a diameter that is larger than an outer diameter of the bottom tubular section. The support includes a pair of opposed, substantially flat stabilizing wings disposed on the shaft beneath the ground surface engaging disk. A pointed tip facilitates driving the support into the ground.

The exterior surface of the flagpole can be selectively painted by silkscreen or the like in shapes and background of different colors and designs to identify a school, organization, institution, sports team, holiday celebration, corporate logo, event, product or the like depicted by the supported flag or otherwise signal the purpose, spirit or environment in which the flag and flagpole are used. For example, if a school flag is to be flown from the flagpole, the present invention contemplates that the flagpole be painted in the school colors, by shapes or the like, or designs which further depict and represent the school. Such coordinated surface painting or coating of the flagpole can thus serve to represent any endeavor. The painting or coating is preferably applied to all sections of the flagpole for visual observation of the design when extended or collapsed.

Accordingly, it is an object of the present invention to provide a flagpole comprising a plurality of elongated tapering telescopic tubular sections which, when extended, are self supporting in a vertical flag supporting condition by friction locking engagement of the sections without the necessity of collars or spring loaded pins to hold the sections in their extended vertical condition.

A further object of the present invention is to provide a telescopic flagpole comprising a plurality of elongated tapering tubular sections which telescopically collapse into a nested condition within the largest, lowermost bottom section.

Another object of the present invention is to provide each of the tubular sections of the flagpole with a lower end that has a greater exterior diameter than the interior diameter of the upper end of the next lower section so as to form a frictional engagement between those ends when the sections are extended and form a tapered tubular pole, with each of the tubular sections gradually decreasing in diameter from the lower end to the upper end.

A further object of the present invention is to provide a telescopic flagpole with a lowermost or bottom tubular section which is larger in diameter and longer in length than the other elongated telescopic tubular sections for supporting the other tubular sections when the flagpole is in the fully extended position and for storing the other tubular sections completely within the lowermost tubular section when collapsed into a nested position.

Still another object of the present invention is to provide a dual purpose telescopic flagpole that is configured both to be portable with pull and twist frictional connections for use in temporary service, and to be structurally secure with reinforcing threaded fasteners for extended use in a permanent location.

It is still another object of the present invention to provide a telescoping flagpole in which the largest, lowermost tubular section includes a bottom end plug of rubber, plastic or the like which closes the bottom of the lowermost section for storing the other tubular sections when collapsed therein and for providing slip resistance when the flagpole is in its extended condition and resting on the bottom end plug.

It is a still further object of the present invention to provide a telescopic flagpole which includes a top end plug that serves both to close the top end of the lowermost section when the other tubular sections are stored in nested condition therewithin and close the top of the smallest and uppermost tubular section which forms the top of the flagpole when all of the tubular sections are in their extended condition.

Still another object of the present invention is to provide a telescoping flagpole with a portable support or holder which is adaptable for securing the lowermost tubular section on the ground or other horizontal surface when the flagpole is in its fully extended condition and which will also fold alongside the lowermost tubular section for easy shipping, handling and storage.

Another object of the present invention is to provide an insertable sleeve so that the flagpole holder can be used with telescopic flagpoles of various lengths having bottom tubular sections of differing diameters.

Yet another object of the present invention is to provide a portable pole holder that is removably insertable into the ground so as to facilitate simple and fast setup of the flagpole for temporary use.

It is still another object of the present invention to provide a flagpole having at least two connectors for easy fastening of the flag to the uppermost section or sections, thus securing the flag to the top of the flagpole for use in the fully extended position, and which allow the attached flag corners to rotate freely around the flag as the wind redirects the flag.

Still another object of the present invention is to provide a telescopic flagpole with the exterior surface selectively painted in shapes and background of different colors and designs to coordinate with the purpose, spirit or environment in which the flag and flagpole are used.

Yet another object of this invention is to provide a telescopic flagpole in accordance with the preceding objects and which will conform to conventional forms of manufacture, be of simple construction and easy to use so as to provide a device that will be economically feasible, long lasting and relatively trouble free in operation.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1A is an elevational view of a fully extended telescopic flagpole according to the present invention with a flag mounted thereon.

FIG. 1B is an enlarged perspective view of a connector assembly in accordance with the present invention which connects each corner of the flag to the flagpole.

FIG. 1C is a top plan view of the component of the connector assembly mounted on the flagpole according to the present invention.

FIG. 1D is a sectional view of the flagpole mounted component of a connector assembly of the present invention, taken along section line 1D-1D on FIG. 1C.

FIG. 2A is an exploded elevational view of the telescopic flagpole of the present invention with each tubular section shown separated from the others with arrows indicating the relative assembly of the sections and stars, background and bands of different colors painted on the exterior surface of the flagpole.

FIG. 2B is an elevational view of the telescopic flagpole of the present invention in a collapsed condition with a top end cap engaged with the upper end of the uppermost tubular section.

FIG. 2C is an enlarged longitudinal sectional view of two adjacent sections of the flagpole of the present invention in their extended position showing the frictional lock between the extension of the lower end of the smaller upper section and the interior of the upper end of the larger lower section.

FIG. 2D is a schematic elevational view of the lower end of the lowermost tubular section and the upper end of the next upper tubular section of the flagpole illustrating the overall angle of taper of the tubular sections and extended flagpole in accordance with the present invention.

FIG. 2E is an elevational view of the telescopic flagpole of the present invention in a collapsed nested condition with the connector assemblies removed and an end cap closing the upper end of the lowest tubular section.

FIG. 3 is an elevational view of the telescopic flagpole with two flags supported by using three connector assemblies according to the present invention.

FIG. 4 is a perspective view of a portable, foldable stand including a tubular support member receiving the flagpole for supporting the flagpole from the ground according to the present invention.

FIG. 5 is an elevational view of the portable foldable stand in FIG. 4 shown in a folded position according to the present invention.

FIG. 6 is an elevational view of the foldable stand supporting the flagpole with a vehicle wheel securing the stand on the ground according to the present invention.

FIG. 7 is a vertical sectional view of a rigid support driven into the ground for receiving and supporting the flagpole according to the present invention.

FIG. 8 is an expanded elevational view of the telescopic flagpole of the present invention similar to FIG. 2A with a black and white square pattern painted on the exterior surface of the flagpole.

FIG. 9 is a transverse sectional view taken along section line 9-9 on FIG. 6 illustrating the structural details of the pivotal connection of the upper end of the knee braces to the tubular support member.

FIG. 10 is a perspective view of the portable, foldable stand of the present invention shown in FIG. 4, including an insertable sleeve for receiving a flagpole having a smaller diameter.

FIG. 11A is an expanded elevational view of the sleeve of the present invention shown in FIG. 10.

FIG. 11B is a sectional view of the sleeve of the present invention, taken along section line 11B-11B on FIG. 11A.

FIG. 12 is an expanded elavational view of the rigid support of the present invention shown in FIG. 7.

### DETAILED DESCRIPTION OF THE PREFERRED EMBODIMENTS

Although preferred embodiments of the invention are explained in detail, it is to be understood that other embodiments are possible. Accordingly, it is not intended that the invention is to be limited in its scope to the details of constructions, and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents that operate in a similar manner to accomplish a similar purpose. Where possible, components of the drawings that are alike are identified by the same reference numbers.

In reference now to the drawings, the telescopic tubular flagpole of the present invention is shown and generally indicated by reference numeral 10. The flagpole 10 is shown in a vertical position with a flag 11 attached at the top thereof. While the primary intended use is for flying a country, state or special flag or banner in a yard, dock or parking area, adaptations could be made to fly sports teams flags on lawns or in parking lots at sporting events, such as during “tailgate” parties, parades, at flea markets, trade shows, and in-store retail displays where it may be desirable to fly a flag having a company logo or corporate symbol.

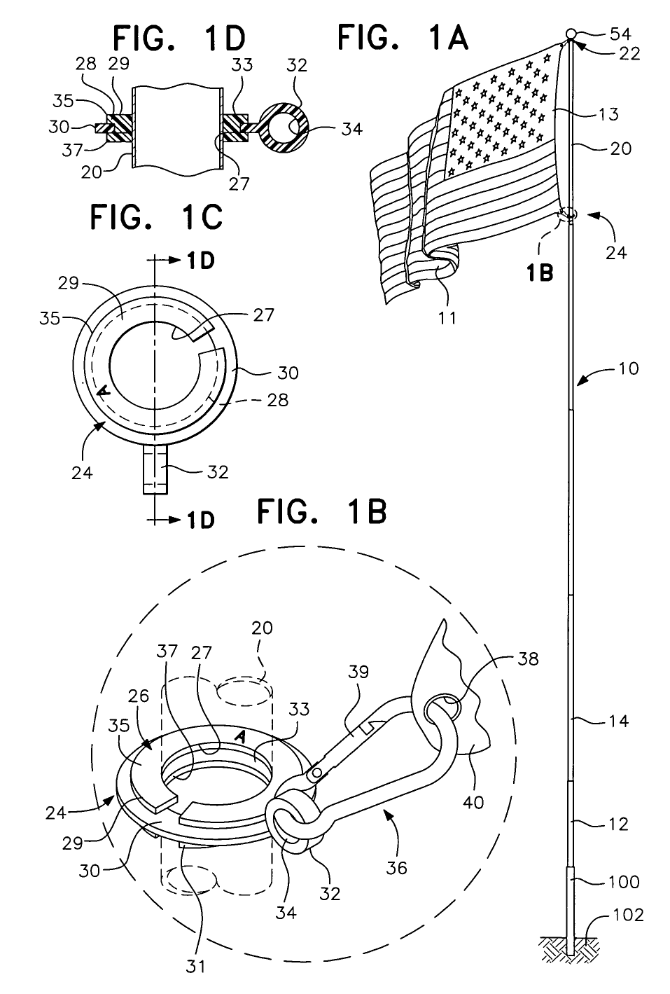

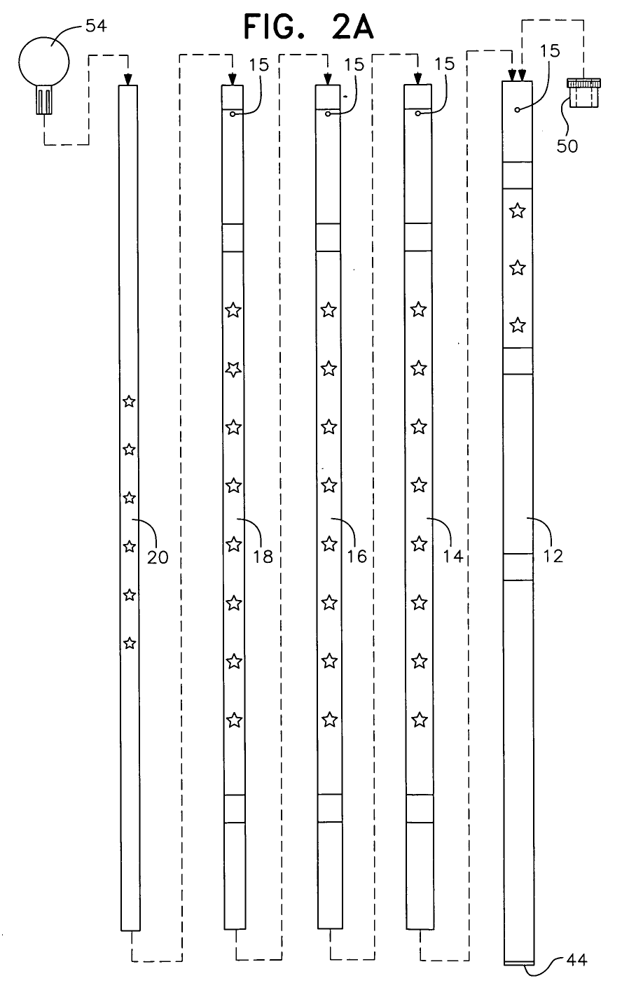

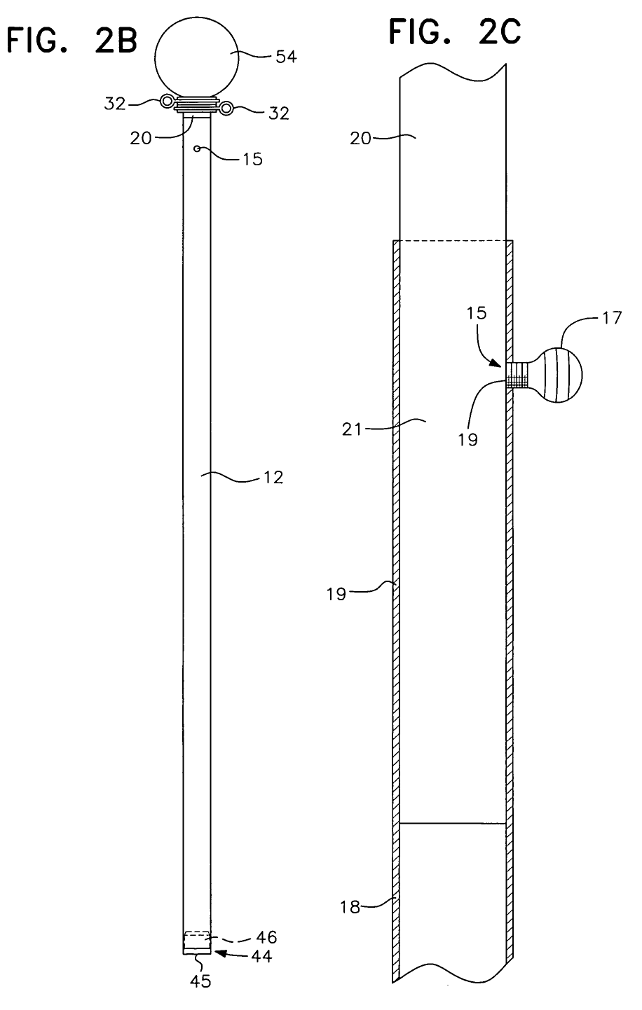

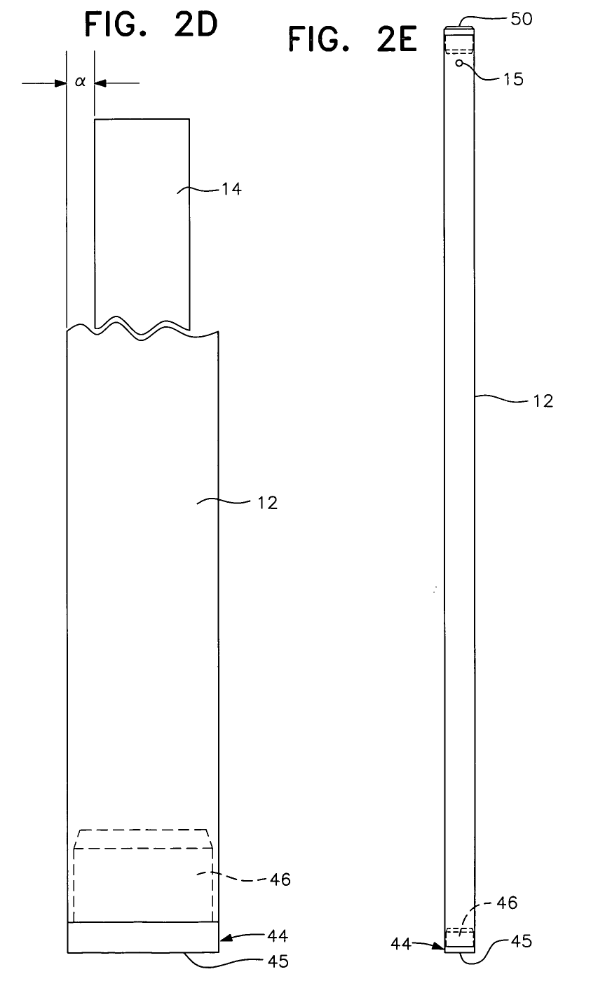

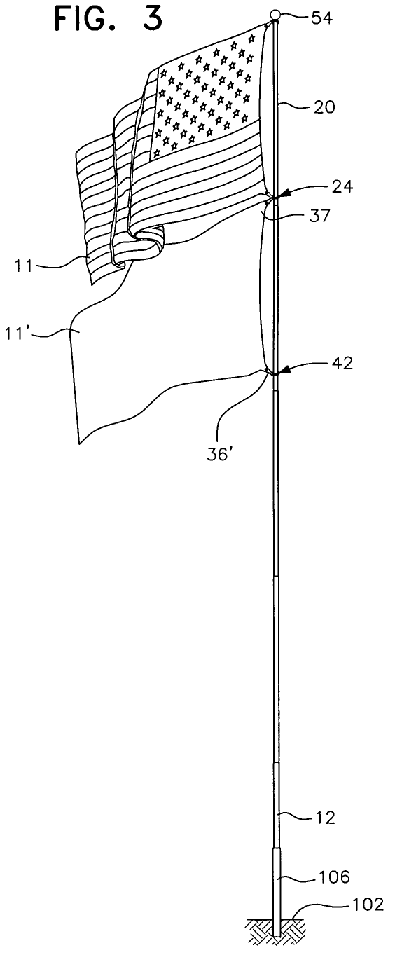

The flagpole 10 includes a plurality of elongated telescopic tubular sections or members 12, 14, 16, 18 and 20, as shown in FIG. 2A for telescoping vertically into a fully extended position to form the flagpole 10. At least two rotating connector assemblies 22 and 24 are provided for fastening the flag 11 to the extended top tubular section 20 for securing the flag 11 to the flagpole 10. As shown in FIGS. 1B, 1C and 1D, each of the two connector assemblies 22 and 24 includes a split annular collar 26 of resilient material which can be slid onto the upper end of tubular section 20. The inside surface 27 of the collar 26 frictionally grips the external surface of tubular section 20 and enables expansion and contraction to secure the connector assemblies 22 and 24 in a selected adjustable position.

The external periphery of each split collar 26 includes a groove 28 which receives a peripherally continuous annular member or ring 30 also of substantially rigid construction. As shown in FIG. 1C, the interior diameter of the annular ring 30 is greater than the external diameter of the bottom of groove 28 in the split collar 26. This enables ring 30 to freely rotate about the flagpole 10 to prevent the flag from wrapping around the flagpole 10 when subjected to changes in wind direction. This also enables the split collar 26 to expand and contract to enable the collar to slide lengthwise on upper tubular section 20 while maintaining a frictional grip therewith to thereby retain the connector assemblies 22 and 24 in adjusted position on upper tubular section 20. The split collar also allows each connector assembly 22 and 24 to be slipped onto the upper end of top section 20 by expanding each of the collars 26 to increase the internal diameter thereof when slipping the connectors 22 and 24 onto the upper end of top section 20 with the resiliency of the collars 26 enabling the diameter of the collars 26 to expand and contract as the connectors 22 and 24 are moved longitudinally on tapered top section 20. The depth of groove 28 is such as to retain the fixed diameter inner edge of annular member or ring 30 rotatably supported in groove 28 on the split annular collar 26.

As shown in FIG. 1D, the split collar 26 is preferably made of two components 29 and 31, with component 29 including the bight portion 33 and flange 35 and component 31 including flange 37. This allows the freely rotating ring 30 to be assembled with component 29 and then component 31 glued or otherwise affixed to position the ring 30 between flanges 35 and 37.

In view of the increase in circumference of the upper tubular section 20, the split collars 26 of connectors 22 and 24 preferably are provided with different internal diameters to facilitate sliding adjustment of the collars on the tubular section 20. The collar 26 in the upper connector 22 has a smaller interior diameter than the collar 26 in connector 24 so that the resilient gripping engagement with the tubular section 20 is approximately the same. One or both of the flanges 35 and 37 of collar 26 are provided with indicia to indicate which connector is placed at an upper and lower position when assembled onto tubular section 20.

The letter “A” may be molded into collar 26 of lower connector assembly 24 to indicate that it should be the first collar 26 to be placed on top tubular section 20 as it has a slightly larger interior diameter and will effectively grip the lower portion of tubular section 20. The letter “B” may be molded into collar 26 of connector assembly 22 to indicate that it should be placed on tubular section 20 after connector assembly 24 as the interior diameter is smaller and will effectively grip the upper portion of tubular section 20. Other types of distinguishing indicia may be used to indicate which connector assembly should be the lower and upper connector assembly.

The continuous annular member or ring 30 includes a rigid ring or loop 32 integral or rigid with the periphery of annular member 30. The ring or loop 32 is preferably perpendicular to annular member 30 and includes opening 34 which receives an openable and closeable spring clip or fastener 36 that also is engaged with a grommet 38 in the corner 40 of flag 11 as shown in FIG. 1B.

The split annular member 26 is preferably made of hard plastic or other resilient material for sliding onto and along flagpole 10 while frictionally engaging the upper tubular section 20 of the flagpole to secure the connector assemblies at a proper location. The split annular mounted member 26 provides additional flexibility in adjusting the location of the connector assemblies 22 and 24 on the flagpole corresponding to the vertical length of the flag.

The spring clips or fasteners 36 are preferably standard oval shaped clips with a spring biased gate 39 on one side thereof for connecting the grommets 38 in flag corners 40 to the ring or loops 32 on annular members 30 as illustrated in FIG. 1B. As shown in FIGS. 1C and 1D, the outer diameter of the split annular member 26 is greater than the inner diameter of the continuous annular member 30 to rotatably retain the continuous annular member 30 in groove 28 even when the split annular member 26 is slid along the tapering upper tubular flagpole sections.

To attach the flag to the pole 10, the upper section 20 of the pole 10 is extended from the next larger section 18. Next, the lower connector assembly 24 is slid over the upper end of upper tubular member 20 and down a distance generally equal to the length of the side edge 13 of the flag 11 intended to be raised as shown in FIG. 1B. The upper connector assembly 22 is slid over the upper end of upper tubular section 20 and is typically positioned several inches below the upper end of tubular section 20. The process is completed by adjusting the connector assemblies 22 and 24 to line up with the grommets 38 in the corners 40 of the flag 11. Next, the clips 36 are opened by pivoting a free end of spring biased gate 39 inwardly to connect the clip 36 to the flag corner grommets 38 and to the loop ring 32 with the clips 36 then being closed by releasing gate 39 to secure the flag corners to the top tubular section 20 as shown in FIG. 1A.

Multiple flags could also be flown using additional connector assemblies and multiple spring clips 36 being attached to the loops or rings 32. For example, as shown in FIG. 3, a second flag 11′ is positioned below the flag 11 as shown in FIG. 1A by adding an additional connector assembly 42 below the connector assembly 24. The upper grommet of the second flag 11′ is connected to the flagpole by connecting to the connector assembly 24 with an additional clip 36′. The lower grommet on the second flag 11′ is connected to the third connector assembly 42 on the flagpole.

FIG. 2A illustrates the plurality of tubular members 12, 14, 16, 18, and 20. Each of the tubular members has an upper end and a lower end. Each lower end has a greater diameter than the upper end with each tubular section gradually and uniformly increasing in diameter from the upper end to the lower end in order to form a constant taper throughout the length of each tubular section. Each tubular section has the same angle of taper on the order of less than 3° and preferably about 1° to about 2°.

To extend the pole 10 to its full length, each upper section is pulled out until the exterior surface of the larger lower end of an upper section engages the interior surface of the smaller upper end of a lower section. The uppermost tubular section 20 has the smallest diameter of the plurality of elongated telescopic tubular sections. As shown in FIG. 2C, the uppermost or top tubular member 20 extends from next larger section 18 of the plurality of tubular sections with an outer surface on a lower end 21 of the top tubular section 20 slidably and frictionally engaging the interior of the upper end 19 of tubular section 18 and frictionally locking section 20 in extended position when pulled in to frictional engagement with section 18. Each of the sections is successively pulled out of the next larger lower section. The lower end of section 18 engages an upper end of section 16, the lower end of section 16 engages the upper end of section 14, the lower end of section 14 engages the upper end of lowermost section 12.

This engagement of the lower ends inside the upper ends of the tapered tubular section provides a tight frictional engagement as each section 20, 18, 16, and 14 is pulled outward of lowermost, longest and largest section 12. If necessary, the sections can be twisted or partially rotated relative to each other as well as pulled to ensure a firm frictional engagement. The tapering engaging surface areas of the tubular sections may be prepared such as by roughening, applying a coating or the like to increase the frictional engagement, but without causing damage to the outer surface from the twisting. This frictional engagement locks each section to its adjacent section or sections. The overlap of the upper end of a larger lower section 18 over the lower end of a smaller upper section 20 as shown in FIG. 2C, is preferably about 4-8 inches or about 10% to 20% of the length of each section.

In the fully extended position, the tubular sections 12, 14, 16, 18, and 20 remain in a stationary upright position. Because of the telescopic make-up of the tapered tubular sections, the “pull and twist” friction-lock securely locks all of the sections together in the extended position. It is believed that this friction-lock is the result of the material selected for the flagpole sections and the selected tapering angle which produce a stable, lightweight and durable flagpole. Reinforced polymeric materials such as fiberglass and graphite reinforced polymers are the preferred materials for the flagpole sections of the present invention, but other reinforcing fibers such as those commercially available under the trademarks “KEVLAR” and “DYNEEMA” and similar type reinforcing materials could also be used to reinforce appropriate polymers.

As shown in FIG. 2D, the taper of the tapering tubular sections imparts a taper to the overall flagpole when in its extended condition, as identified by angle α in FIG. 2D. The taper of the extended flagpole is approximately the same as the taper of the tapered tubular sections, on the order of less than 3° and preferably about 1° to about 2<.

To provide additional structural integrity for the telescopic flagpole, especially when the flagpole is to remain in the erected position for an extended period of time, each of the tubular sections 12, 14, 16, and 18 includes in the upper section end thereof an aperture 15 that is configured to engagingly receive a threaded fastener 17. Each threaded fastener 17 is configured to self thread, i.e., by being manually rotated into each respective aperture 15, so as to provide additional structural integrity for the telescopic flagpole 10 in the extended position. Once the threaded fastener 17 has been threaded into the aperture 15, a bottom end 19 of the threaded fastener 17 extends through the upper section end so as to frictionally engage an outer surface of the lower end of the next higher section. The threaded fastener 17 is removable from, and reinsertable into, the aperture 15. For extended use and even permanent use, this additional connection provided by the aperture 15 and the threaded fastener 17 securely locks the plurality of elongated sections in the fully extended position.

The bottom end of the lowermost or bottom section 12 of the flagpole 10 is provided with an end plug 44 of rubber, plastic or the like that seals the bottom end of the lowermost section 12 of the flagpole in either the extended flag waving condition or the collapsed storage condition. The lowermost portion 45 of the bottom end plug 44 has the same or slightly larger external diameter as the bottom end portion of the lowermost section 14 of the flagpole as illustrated in FIGS. 2B and 2D. This feature allows the flagpole to be held securely in a vertical position. The bottom end plug 44 has an upper portion 46 telescoped into and secured to the bottom end of the lowermost section 12 and secures all the flagpole sections in place by not allowing the smaller upper sections to fall from the bottom of the largest lowermost section 12 of the flagpole. The sealed bottom of the lowermost section also prevents moisture and dirt particles from entering the inside of the flagpole that could reduce the friction locking effect of the flagpole sections when extended. The lowermost portion of the end plug includes a bottom surface designed to protect the bottom of the pole from the shock of collapsing the flagpole sections with the non-slip surface of the plug 44 retarding any slipping of the bottom end of the flagpole when it is in the extended vertical condition.

The top end of the flagpole is also provided with a top end plug 50 for capping the upper end of tubular section 12 when the flagpole is in collapsed condition as shown in FIG. 2E. The top end plug 50 is preferably also made from rubber or other elastomeric material and has a hollow reduced diameter vertical extension 52 extending from its lower end. The extension 52 has an outer diameter slightly smaller than the upper end of the bottom section 12 to form a snug friction fit in the upper end of tubular section 12 to secure the plurality of tubular sections in their collapsed position within bottom tubular section 12 for storage. The inside diameter of the hollow plug extension 52 is sized to fit snugly over the upper end of smaller tubular section 20 which forms the upper end of the flagpole 10 when the elongated telescopic tubular sections are fully extended in order to close the top end of the flagpole when in use. FIG. 2E illustrates the flagpole 10 in collapsed and nested condition.

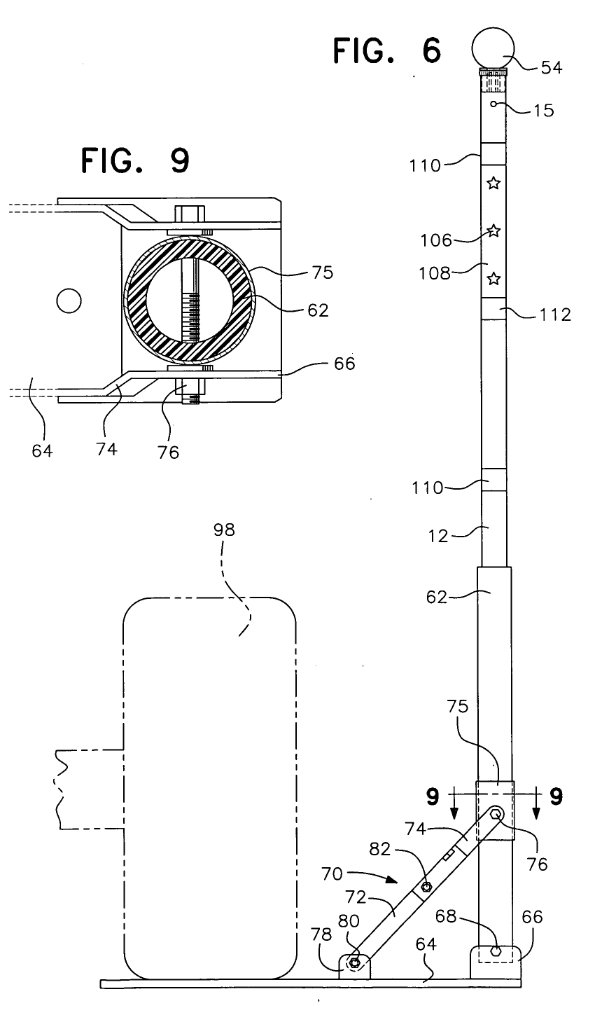

Alternatively, a top end plug 54 in the shape of an ornamental round ball can be used (see FIG. 2A). It has a vertical extension 56 extending downwardly from the ball. The outer diameter of the hollow plug extension 56 is sized to fit snugly into the upper end of the upper section 20 when the elongated telescopic sections are fully extended or are in their collapsed position for storage. FIG. 2B shows the flagpole in collapsed condition with connector assemblies 22 and 24 and the top end plug 54 on the upper end of the tubular section 20. Also, the hollow vertical extension 52 on plug 50 can have an interior dimension to receive the extension 56 on ball plug 54 to support the plug 54 on plug 50 in the upper end tubular section 12 when the tubular sections are in fully collapsed position as shown in FIG. 6.

FIG. 2B illustrates the tubular sections collapsed but with upper section 20 slightly extended to store the connector assemblies 20 and 24 at the upper end thereof with the resilient split collars 26 gripping and engaging the upper section 20. This arrangement enables the ball shaped plug 54 to be mounted on the upper end of upper section 20 by insertion of extension 56 into the upper end of section 20 to securely friction lock plug 54 in place which also retains connectors 22 and 24 on the upper end of upper section 20 even if the resilient split rings 26 do not function to hold the connector assemblies 20 and 24 in place.

When the flagpole 10 is ready for collapsing from its extended position, it is only necessary to twist each section with respect to its next larger section to disengage the frictional fit and allow the upper smaller section to slide into the lower larger section. If, of course, the flagpole has been deployed with the threaded fasteners 17 threaded into the apertures 15, each of the threaded fasteners 17 is first unthreaded from and removed from its respective aperture 15 before twisting the sections to release the friction lock and collapse the sections. As each smaller upper section is slid into its adjacent larger lower section, all of the tubular sections 14, 16, 18, and 20 are collapsed within the bottom section 12. As shown in FIG. 2B, when the pole 10 is in its collapsed position, the top end plug 50 can be placed on the top end of tubular section 12 by fitting extension 52 therein. The bottom end plug 44 and top end plug 50 retain all of the collapsed sections 14, 16, 18 and 20 within the bottom tubular section 12 for storage or transportation.

The bottom tubular section 12 is larger in diameter, longer and heavier, than the other telescopic tubular sections because section 12 serves to support the other elongated tubular sections when in the fully extended position and receives each of the other tubular sections in the collapsed position for storage, ease of handling and transport. Because of the design of the flagpole of this invention, the bottom tubular section 12 has the size in length, thickness and diameter to receive all of the tubular sections inside. This arrangement permits all of the other telescoping tubular sections to be nested within the bottom tubular section for storage and transport without the need for a separate case.

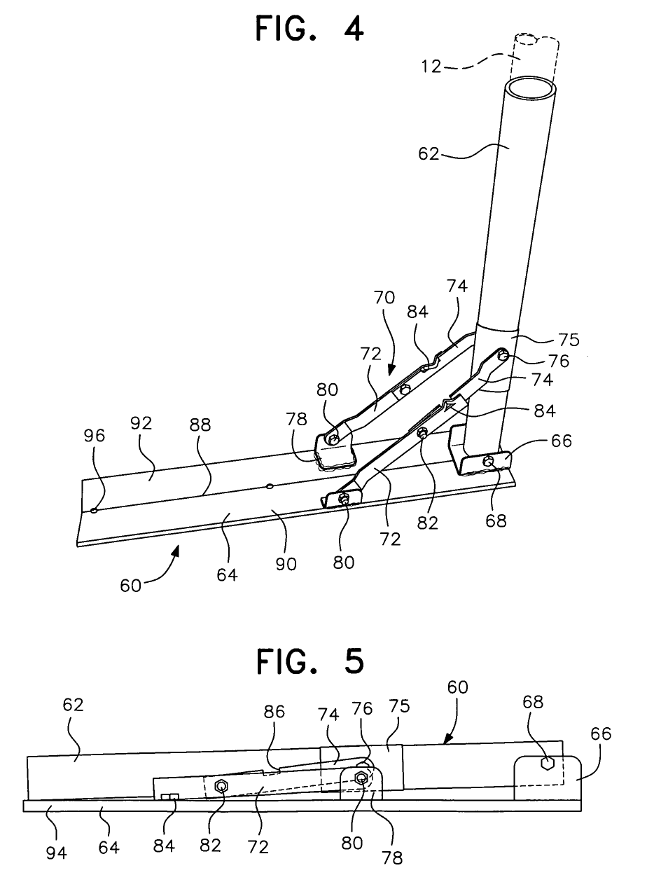

In addition to supporting the flagpole by manually holding section 12 in the hands, other supports can be provided. In one embodiment of support according to the present invention, a portable, foldable stand or bracket structure 60 is provided as illustrated in FIGS. 4, 5, and 6. The stand 60 can be used on docks, piers, boats, the ground or other solid horizontal surfaces and includes a tubular support member 62 of rigid material and an elongated rectangular metal plate 64. A U-shaped bracket 66 is affixed to the upper surface of plate 64 adjacent one end thereof as by welding, fasteners or the like. The bracket 66 receives and pivotally supports the lower end of tubular support member 62 by pivot pin or bolt 68. The tubular support member 62 has an inner diameter larger than the outer diameter of the tubular section 12 in order to telescopically receive the tubular section 12 into the tubular support member 62.

A pair of foldable knee braces, generally designated by reference number 70, interconnect the tubular support member 62 and plate 64 in spaced relation to pivot bolt or pin 68. Each of the foldable knee braces 70 includes a pair of rigid links 72 and 74. The links 74 have one end pivotally connected to tubular support member 62 by pivot pin or bolt 76 spaced from pivot pin or bolt 68. The bolt 76 penetrates the tubular support member 62 and a short cylindrical sleeve 75 that encircles and reinforces the tubular support member 62, as shown in FIGS. 4 and 9. Pivot pin or bolt 76 is engaged by the lower surface of the bottom end plug 44 when the tubular support member 62 telescopically receives the tubular section 12 into the tubular support member 62. The resilient lower end plug 44 cushions the shock of engaging bolt 76 if the flagpole is dropped into tubular support member 62. Links 72 have one end pivotally connected to a bracket 78 rigidly attached to plate 64 also by welding of the like. Pivot pins or bolts 80 also spaced from pivot pin or bolt 68, pivotally connect links 72 to bracket 78 on plate 64. The other ends of links 72 and 74 overlap when supporting the tubular support member 62 in vertical position as shown in FIGS. 4 and 6. The end of link 74 is pivotally connected to link 72 by pivot bolt 82 that is spaced from the end of link 72 as shown in FIGS. 4 and 5. This structure enables the links 72 and 74 to pivot or fold between a generally straight line position as shown in FIG. 4 and a folded or overlapped position as shown in FIG. 5 when tubular support member 62 is pivoted between a generally vertical flagpole supporting position of FIG. 4 and a generally horizontal folded position overlying the upper surface of plate 64 as illustrated in FIG. 5.

To lock the tubular support member 62 in the flagpole supporting position of FIGS. 4 and 6, the end of link 72 which extends beyond pivot bolt 82 includes an inwardly extending projection 84 on a side edge thereof remote from the pivot pin or bolt 68 when the links 72 and 74 are in generally aligned position illustrated in FIGS. 4 and 6. The links 74 each include a notch 86 in a corresponding side edge to receive the projection 84 when the links 72 and 74 are pivoted from their folded position of FIG. 5 to their operative position of FIG. 4 as support member 62 is moved from the position of FIG. 5 to the position of FIG. 4. The depth of notches 86 is such that the links 72 and 74 can pivot slightly beyond a straight aligned position thereby enabling pivot bolt 82 to move slightly downwardly below a straight line between pivot bolt 76 and 80. Thus, when projection 84 engages the bottom of notch 86, the links are locked in the position of FIG. 4 thereby locking the support member 62 in vertical position. The pivotal connection between the overlapping ends of the links is manually moved by exerting hand pressure on the links 72 and 74 adjacent bolt 82 to move the links between overcenter locked position and unlocked folded position.

The plate 64 preferably is a shallow angled cross section and includes a central line 88 and two upperwardly and outwardly inclined panels 90 and 92. Both panels 90 and 92 have downwardly extending rigidifying flanges 94 on their side edges. The plate 64 also includes holes 96 along center line 88 to enable it to be nailed to a deck, flooring, or the like through the holes 96. As illustrated in FIG. 6, spikes can be inserted through holes 96 to anchor plate 64 to a ground surface or the like. As illustrated in FIG. 6, a vertical tire and wheel 98 can be driven onto the rectangular plate 64 to securely hold the plate 64 on a supporting surface and support the flagpole and flag in a vertical position. The structure is especially useful to support a team flag or pennant in a parking lot when attending a sporting event. The two inclined panels 90 and 92 serve to form a cradle to provide more secure engagement of the vehicle wheel 98 on the plate 64.

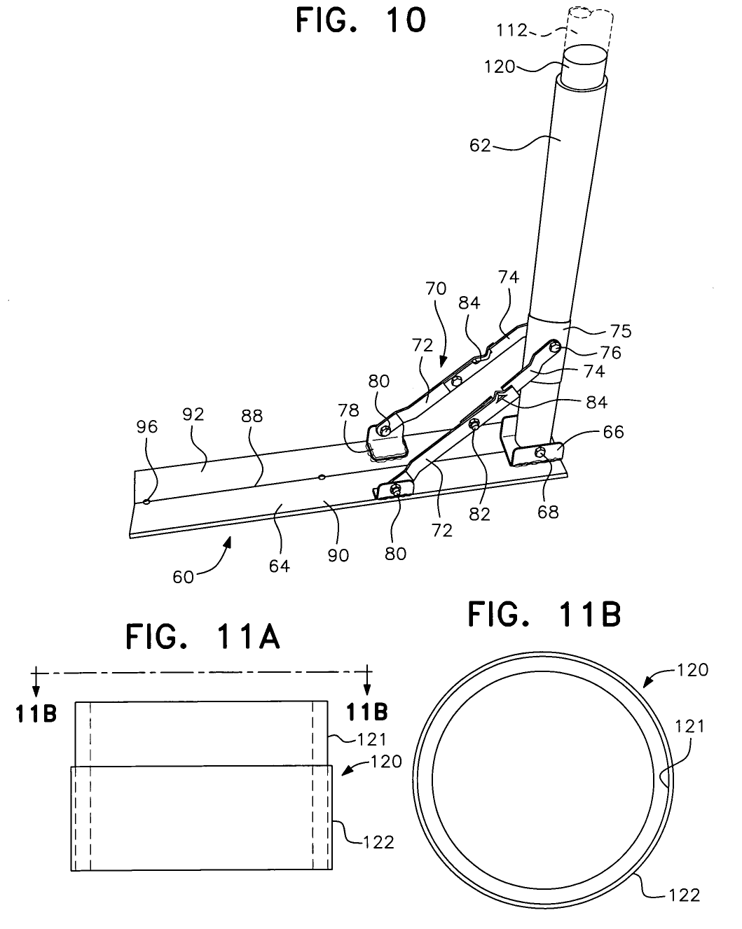

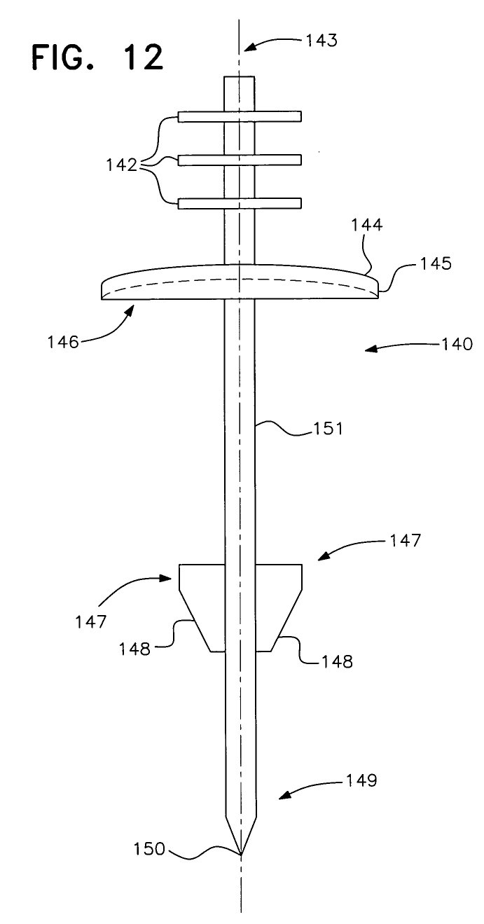

To ensure that the foldable stand 60 can be used with telescopic flagpoles 10 of various lengths, an insertable and removable sleeve 120 is provided for the support member 62 of stand 60. As shown in FIGS. 10, 11A, and 11B, the sleeve 120 is generally a rigid annular ring with an outer diameter 121 that is smaller than the inner diameter of the support member 62. The sleeve 120 has a layer of material 122 thereon that can frictionally engage the inner surface of support member 62 so as to hold the sleeve 120 securely in place within the support member 62. In a preferred embodiment of the invention, the layer of material 122 is a layer of a hook-and-loop type fastener commercially available under the trademark “VELCRO.” With the insertable sleeve 120 inserted in the support member 62, a shorter length flagpole, i.e., one having a bottommost tubular section 112 with a lesser diameter than, for example, the above-described bottom tubular section 12, can be supported in the support member 62. This ensures that, for example, a 22-foot flagpole according to the present invention as well as a 16-foot embodiment thereof can be used with the foldable stand 60.

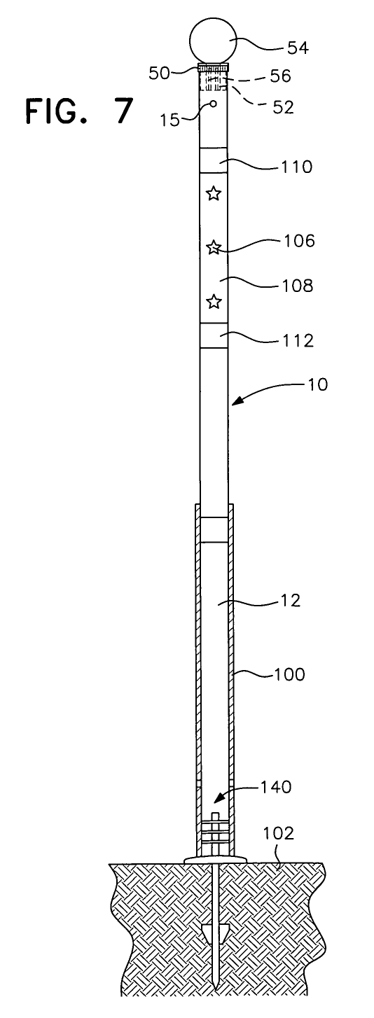

In another embodiment of the present invention as illustrated in FIGS. 7 and 12, the supporting structure for the flagpole 10 is a rigid support 140. Typically employed for temporary use of the flagpole 10, support 140 is portable and is configured to (i) receivingly engage the bottom tubular section 12 of the flagpole 10 and (ii) be removably insertable into a ground surface 102. The support 140 includes generally a shaft 151 with an upper section 141 having a plurality of bottom tubular section support disks 142 disposed along an axis 143 of the shaft. The disks 142 are configured to frictionally engage and support an inner surface of the bottom tubular section 12. A ground surface engaging disk 144 is disposed on the shaft 151 beneath the disks 142. The ground engaging disk 144 has an outer edge 145 with a diameter that is larger than an outer diameter of the bottom tubular section 12 and a shallow concave bottom side 146 for engaging the ground surface 102. The support 140 includes a pair of opposed, substantially flat stabilizing wings 147 disposed on the shaft 151 beneath the ground surface engaging disk 144. Each of the stabilizing wings 147 has an edge 148 that is inclined downward toward a bottom end 149 of the shaft 151. A pointed tip 150 configured for driving the support 140 into the ground surface 102 is disposed on the bottom end 149 of the shaft 151. The support 140 is driven into the ground surface 102 by using an impact implement to a depth sufficient to support the flagpole and flag.

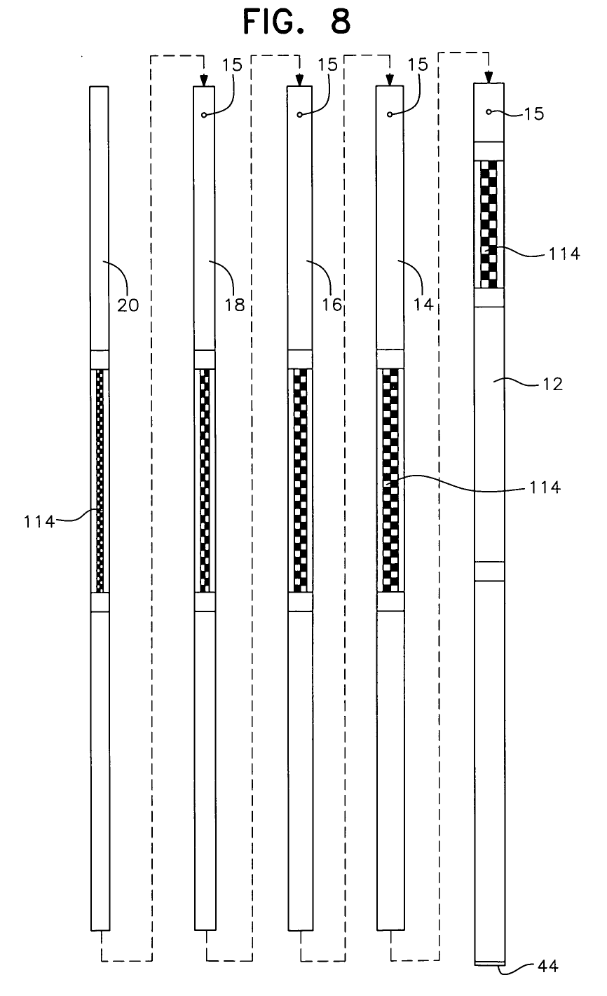

The exterior surface of the flagpole 10 is selectively painted with figures and backgrounds of different shapes and colors compatible with the environment in which the flag and flagpole are used or reflect the purpose for which the flag or flagpole is used. For example, as shown in FIGS. 2A and 6, the exterior surface of the lowest section 12 can have white stars 106 in a blue color background or field 108 adjacent an upper end, an elongated blue area 108 at the lower end, red color bands 110 and white areas or bands 112 to resemble and indicate the red, white and blue patriotic theme of the United States national flag. Another embodiment of exterior surface is shown in FIG. 8, in which the exterior surface of each of the tubular sections has a checkerboard white-black block area to reflect the winning flag used in auto racing. These examples are for illustration only, since the exterior can also have other surface depictions of a country, state or special flag or banner. Adaptations of painting on the exterior surface of the flagpole could be made to depict sports team's colors, mascots, flags used in parades, at flea markets, trade show, in-store retail displays with company logos, corporate symbols, holiday celebrations, political parties and various organizations or the like on the exterior surface of the flagpole.

While fiberglass and graphite impregnated polymers, and preferably fiberglass, are preferred materials for the present invention, other materials may be found suitable, so long as they can be molded or formed into the desired tapered shape of the multiple telescoping tubular sections. For example, other reinforcing fibers such as those commercially available under the trademarks “KEVLAR” and “DYNEEMA” and similar type reinforcing materials, or combinations of reinforcing materials, could be used to reinforce any appropriate polymeric material which can be molded or formed into the desired tapered shape. Non-conductive materials are preferred to eliminate any possibility of electric shock in the event of accidental contact with overhead electric wires. Further, while a circular shape for the cross-section of the telescoping tubular members is clearly preferred, polygonal shapes could be utilized. While five tubular sections are preferred, as disclosed in FIGS. 1A and 2A, it will be appreciated that more or fewer could be used in the present invention.

In one preferred form of the invention, the intermediate sections 14, 16, and 18 and top section 20 are approximately 43 inches in length and the lowermost bottom section 12 is approximately 4 inches longer, or about 47 inches. Each of the tubular sections taper with the outside diameter of the lower end of section 12 being approximately 1 9/16 inches and tapering to about 15/16 inch at the upper end of top section 20. When the sections are fully extended to form the flagpole, the upper and lower ends of the overlapping sections overlap from about 5 inches to about 6½ inches. In a second preferred form of the invention, the section lengths and overlaps are the same, and the lower end of bottom section 12 has an outer diameter of about 1 5/16 inches tapering to about ⅞ inches at the upper end of top section 20. It is not intended that the present invention be limited to the specific device described herein.

As indicated above, an object of the present invention is to provide a telescopic flagpole that is configured both to be portable for use is temporary service and to be structurally secure for extended use in a permanent location. The telescopic features of the flagpole are, of course, important to its ease of set up and takedown, and thus its portability. The combination of the “pull and twist” feature and the threaded fastener feature provide the degree of structural integrity that is desirable for extended use in a permanent location. Even after the flagpole has been used in the permanent location, however, it can still easily be converted for temporary use. To convert the “permanent” flagpole to a “portable” flagpole, the threaded fasteners are removed, the pull and twist connections are unsecured, the tubular sections are collapsed to nest, and the flagpole becomes a portable “quick-set” flagpole for temporary applications. After the temporary service, the flagpole can, of course, be returned to the permanent site with the threaded fasteners once again in place to secure the extended flagpole for an extended period of time.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A flagpole comprising:
a plurality of elongated telescopic tubular sections, made of generally rigid, lightweight material, each said section having an upper end and a lower end, said lower end having a diameter greater than a diameter of said upper end, each said section gradually increasing in diameter from said upper end to said lower end to form tapered sections;
said plurality of sections connecting in a fully extended position to form said outdoor flagpole for extending in a generally vertical direction and for collapsing telescopically into a collapsed position for storage;
said flagpole, when in said fully extended position, including a friction connection between each upper section end and a lower end of a next higher section for securing said plurality of elongated sections in said fully extended position when said outdoor flagpole extends in a generally vertical direction, at least one of said sections including in said upper section end an aperture configured to engagingly receive a threaded fastener therein, a bottom end of said threaded fastener extending through said upper section end so as to frictionally engage an outer surface of said lower end of the next higher section to lock said plurality of elongated sections in said fully extended position;
a bottom tubular section of said plurality of elongated telescopic tubular sections supporting said plurality of elongated telescopic tubular section when in said fully extended, frictionally locked, generally vertical position, said bottom tubular section having the largest diameter and longer in length than any other of said plurality of elongated telescopic tubular sections for receiving other said plurality of elongated tubular sections in said collapsed position completely within said bottom tubular section;
a top tubular section having the smallest diameter of said plurality of elongated telescopic tubular sections, said top tubular section extending from one of said plurality of tubular sections with the lower end of said top tubular section slidably engaging the upper end of said one of said plurality of tubular sections until reaching said fully extended position; and
at least two connector assemblies on said top tubular section for fastening a flag thereto.

2. The flagpole according to claim 1, further comprising a support configured to engage said bottom tubular section so as to support said flagpole.

3. The flagpole according to claim 1, wherein each of said tubular sections except said top tubular sections includes said aperture and said threaded fastener.

4. The flagpole according to claim 1, wherein said threaded fastener self threads into said aperture.

5. The flagpole according to claim 1, wherein said threaded fastener is removable from, and reinsertable into, said aperture.

6. The flagpole according to claim 2, wherein said support is a foldable support stand configured to engage said bottom tubular section of said flagpole, said stand including (i) an elongated tubular support member with an inner diameter larger than a diameter of said bottom tubular section of the flagpole for receivingly engaging said bottom tubular section of the flagpole, (ii) a rigid rectangular plate for engaging a support surface having one end pivotally connected with a bottom end of said tubular support member, and (iii) at least one foldable brace pivotally connected to said tubular support member and said rectangular plate in spaced relation to the pivotal connection between said plate and tubular support member.

7. The flagpole according to claim 6, further comprising a sleeve that is insertable into said elongated tubular support member so as to enable said support member to support a shorter length flagpole by receiving a bottom tubular section of reduced diameter.

8. The flagpole according to claim 7, wherein said sleeve is removable from said elongated tubular support member.

9. The flagpole according to claim 7, wherein said sleeve is a rigid annular ring with an outer diameter that is smaller than said inner diameter of the elongated tubular support member, an outer surface of said sleeve having thereon a layer of material that frictionally engages an inner surface of said elongated tubular support member so as to hold said sleeve in place.

10. The flagpole according to claim 9, wherein said material is a hook-and-loop fastener.

11. The flagpole according to claim 1, further comprising a bottom end plug for sealing a bottom end of the flagpole in either said extended or collapsed position, said bottom end plug having a diameter comparable to the diameter of said lower end of said bottom tubular section for securely fitting on said bottom tubular section,
a top end plug for capping a top of the flagpole when in said extended position and having an outer diameter slightly smaller than said upper end of said bottom section to form a snug fit for securing the plurality of tubular sections when in said collapsed position for storage.

12. The flagpole according to claim 1, further comprising a third connector assembly provided on a tubular section of the flagpole to support a second flag, with an upper grommet on said second flag being connected to one of said at least two flag connector assemblies on said flagpole, and a lower grommet on said second flag being connected to said third connector assembly.

13. The flagpole according to claim 1, wherein each of said connector assemblies for fastening a flag to said flagpole includes
a split annular flagpole mounted member encircling said flagpole and having an outer surface including a recessed groove, said split annular member being constructed of resilient material and having an inner diameter to frictionally engage said flagpole to enable sliding movement of said split annular mounted member along said flagpole and frictionally securing said split annular member in adjusted position on the flagpole,
a rigid ring member rotatably mounted in said recessed annular groove of each said split annular mounted member, and
a fastener securing corners at one end of said flag to said ring members to retain an edge of said flag generally straight and permitting the flag to move freely around the flagpole in response to wind currents without wrapping around the flagpole.

14. The flagpole according to claim 13, wherein each of said ring members includes an outwardly extending attaching ring rigidly connected thereto, each of said flag corners securing fasteners releaseably engaging said attaching ring and a grommet in the corner of the flag.

15. The flagpole according to claim 13, wherein each of said rigid ring members includes an inner diameter greater than the outer diameter of a bottom surface of said groove in all positions of said split annular member made of resilient material frictionally and resiliently engaging said flagpole to enable assembly and disassembly of said flag, annular members and flagpole mounted members when extending and collapsing said flagpole.

16. The flagpole according to claim 6, wherein said rigid rectangular plate is configured to be positioned on a generally horizontal ground surface, said rigid rectangular plate including a shallow angled cross section formed by two upwardly and outwardly inclined panels to enable a vehicle tire to be driven onto said rectangular plate and contact said both panels to anchor said foldable support stand to said ground surface and support said flagpole in a generally vertical position.

17. The flagpole according to claim 6, wherein said foldable brace includes a first rigid bar pivotally connected to said tubular support member, a second rigid bar pivotally connected to an end portion of said first rigid bar, said second rigid bar being pivotally connected to said plate in spaced relation to the pivotal connection between said plate and said tubular support member and a locking device on said bars in spaced relation to the pivotal connection therebetween for keeping said first rigid bar and said second rigid bar of said foldable brace in a substantially straight-line position when said plate and support tubular member are in perpendicular relation to support the flagpole in the vertical position.

18. The flagpole according to claim 17, wherein said first and second bars include a coacting projection and recess to releasably retain said bars in a straight line position to support said support tubular member in a generally vertical position relative to said rectangular plate.

19. The flagpole according to claim 2, wherein said support is portable and is configured to (i) receivingly engage said bottom tubular section of the flagpole and (ii) be insertable into a ground surface.

20. The flagpole according to claim 19, wherein said support is configured to be driven by force into the ground.

21. The flagpole according to claim 20, wherein said support is configured to be removable from the ground by manual force.

22. The flagpole according to claim 19, wherein said support is a rigid shaft, said shaft including (i) an upper section having a plurality of bottom tubular section support disks disposed along an axis of said shaft, said disks configured to frictionally engage and support an inner surface of said bottom tubular section, (ii) a ground surface engaging disk disposed on said shaft beneath said disks, said ground engaging disk having an outer diameter that is larger than an outer diameter of said bottom tubular section and having a concave bottom side for engaging the ground surface, (iii) a pair of opposed stabilizing wings disposed on said shaft beneath said ground surface engaging disk, each of said stabilizing wings having an edge that is inclined downward toward a bottom end of the shaft, and (iv) a pointed tip disposed on said bottom end of the shaft, said pointed tip being configured for driving the shaft into the ground.

23. The flagpole according to claim 1, wherein said upper end of each tubular section has an inner diameter which is smaller than an outer diameter of said lower end of the next smaller tubular section so that said upper end of each tubular section overlaps and frictionally engages said lower end of the next smaller tubular section.

24. The flagpole according to claim 1, wherein said flagpole is configured for at least one of permanent use in a fixed location and temporary, portable use.
